(19) United States
(12) Patent Application Publication
(10) Pub. No.: US 2012/0072528 A1
(43) Pub. Date: Mar. 22, 2012

(54) METHODS OF PROCESSING REQUESTS FOR CONTENT AND INITIATING AN INTERCONNECTION FOR THE CONTENT

(75) Inventors: Ivica Rimac, Tinton Falls, NJ (US); Uichin Lee, Yuseong-gu (KR)

(73) Assignee: ALCATEL-LUCENT USA INC., Murray Hill, NJ (US)

(21) Appl. No.: 12/884,994

(22) Filed: Sep. 17, 2010

(51) Int. Cl. G06F 15/16

(52) U.S. Cl. 709/217

(57) ABSTRACT

At least one example embodiment is directed to a method of processing a request for content including storing, at a network element, user information for a plurality of users, the user information including a location of the user and received content information, receiving a request for content from a requester, determining a potential peer from the plurality of users based on the request for content and the user information, and sending a response to the requester based on the determining

[symbol]

### BACKGROUND

Cellular, Wi-Fi, radio, and other wireless/mobile communications networks conventionally allow individual users connected to the network to send and receive a variety of data, services, and media, including both on-deck and off-deck content such as voice, SMS, html, email, IPTV, Internet radio, streaming video, etc. Such information is conventionally retrieved through the network, via a home agent or other centralized, network-controlled element having a high-bandwidth connection to the media providers (e.g., the Internet) or stored content. The services and/or media are then distributed to individual users from the centralized network element via existing wireless connections between the users and network, i.e., in a “vertical” fashion.

As the demand for content rises, the required bandwidth for a network increases and, if the demand is too high, the network will be overloaded. Results from overloaded networks, such as spotty services and delayed downloads, severely degrade a user's experience.

For example, a conventional Third Generation (3G) network in the United States lacks the spectrum and transmission resources to provide 40% of its subscribers with streaming or downloaded video of 8 minutes in length in any given day.

Currently, network operators rely on expensive solutions to mitigate network overloading by deploying additional hardware or by relying on hotspot assisted traffic off-loading.

Hotspot access points move bits of information received over a wireless channel directly to a wired broadband Internet connection. The wireless channel may be implemented using Wi-Fi, for example. A network operator may allow a user to connect to a Wi-Fi hotspot and transfer data from the Internet via the Wi-Fi hot spot. For example, a network operator may allow its users to connect to Wi-Fi hotspots located at a coffee shop, airport, restaurant and other popular locations.

However, assisted traffic off-loading does not sufficiently prevent network overloading because of limited coverage. For example, a location having many users, such as a subway station, may not have any Wi-Fi available. Moreover, finding opportunistically available Wi-Fi hotspots requires user equipment (UE), such as a mobile device, to constantly scan Wi-Fi channels, thus draining a battery of the UE because the Wi-Fi interface is continuously active.

### SUMMARY

Example embodiments are directed to methods of processing requests for content and methods of initiating interconnection between users.

At least one example embodiment provides a method of processing a request for content including storing, at a network element, user information for a plurality of users, the user information including a location of the user and received content information, receiving a request for content from a requester of the plurality of users, determining a potential peer from the plurality of users based on the request for content and the user information, and sending a response to the requester based on the determining.

At least some example embodiments provide a method of initiating an interconnection between a requester of a plurality of users and a potential peer of the plurality of users including storing, at a network element, user information for the plurality of users, the user information including a location of the user and received content information, receiving a request for content from the requester, first determining a data spot of the requester, the data spot being an area where the requester has communicative access to transmission resource(s) for access and consumption of requested content, second determining the potential peer in the data spot based on the first determining, and transmitting a response to the requester and an enable signal to the potential peer if the requester is located in the data spot.

### BRIEF DESCRIPTION OF THE DRAWINGS

Example embodiments will be more clearly understood from the following detailed description taken in conjunction with the accompanying drawings. FIGS. 1-5 represent non-limiting, example embodiments as described herein.

FIG. 1 illustrates a conventional Unified Cellular and Ad hoc Network (UCAN);

FIG. 2A illustrates a network architecture according to an example embodiment;

FIG. 2B illustrates a method of extending the coverage of existing Wi-Fi hotspots;

FIG. 3 illustrates an overview of a data spot map according to an example embodiment;

FIG. 4 illustrates a method of processing a request for content; and

FIG. 5 illustrates a method of initiating an interconnection between a network user and a potential peer according to an example embodiment.

### DETAILED DESCRIPTION

While example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes (e.g., a scheduler located at a cell site, base station or Node B). Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of example embodiments are typically encoded on some form of tangible (or recording) storage medium or implemented over some type of transmission medium. The tangible storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. Example embodiments are not limited by these aspects of any given implementation.

As used herein, the term “network user” may be synonymous to a mobile user, mobile station, mobile terminal, user, subscriber, wireless terminal and/or remote station and may describe a remote user of wireless resources in a wireless communication network.

Although current network architectures may consider a distinction between mobile/user devices and access points, the example embodiments described hereafter may generally be applicable to architectures where that distinction is not so clear, such as ad hoc and/or mesh network architectures, for example.

As used herein, a “network operator” or “network” is defined as any communications scheme transmitting at least some information wirelessly in at least a portion of the network, including, for example, 4G, CDMA, Wi-Fi, GSM, 802.11, infrared, Bluetooth, GPS satellite, and/or any other suitable wireless technology or protocol.

Similarly, as used herein, “content” is defined as all data, information, services, programs, and media, complete or partial, that may be communicated to or among UE in a network, including, for example, voice, SMS data, voicemail, email, network services, html, real-time information like sports scores, traffic, news, or weather, streaming music, publicly-downloadable files, streaming video, downloadable video files, ringtones, flash application, Java applications, etc.

As used herein, a “data spot” refers to an area available for data transfer. More specifically, a data spot is a geographic area having communicative access to sufficient transmission resource(s) for access/consumption of requested content. For example, wireless data usage generally peaks during commuting hours or during special events such as sporting events or concerts. Network users tend to be clustered during these periods and at certain locations such as a bus stop, train station, football stadium, etc. Thus, the network user density is higher at these spots. Data spots generally change slowly over time (e.g., commuting hours), or can be formed in an ad hoc fashion (e.g., football games or concerts). Analogously, Wi-Fi hotspots can be considered data spots as well.

The inventors have recognized that, in addition to a vertical data delivery from a network or a stationary Wi-Fi hotspot, one or more other pieces of user equipment may provide requested content that is unavailable from a network or would consume fewer network transmission resources in doing so. For example, requested content that would be otherwise transmitted from the network and consume network spectrum or other network transmission resources may instead be transferred from one or several network users that have previously or concurrently acquired the requested content. Such transfer may occur over any protocol of transferring data between user equipment, with or without network facilitation, including Bluetooth, Wi-Fi, 802.11a/b/g/n, etc.

Similarly, one or more pieces of user equipment may supply the requested content alone or in combination with network-based, vertical transmission resources, such as base stations. For example, a Java application, or app, running on a piece of user equipment may gather content from multiple financial websites and analyze the same for a user savings portfolio to be displayed on the user equipment. The app may acquire some content, such as real-time stock quotes and interest rates, from nearby network users having the quotes and rates, while acquiring other content, such as a user's stock holdings and banking information, from the network via a base station operated by the network, all while gathering yet further content, such as currency exchange rates or home mortgage rates, from a nearby stationary public Wi-Fi hotspot, so as to deliver desired app functionality with several pieces of content from both the network and other user equipment or non-network transmission resources. Additional examples and details of processes of acquiring requested content from several transmission resources, including other network users, is hereinafter defined as “sideloading”.

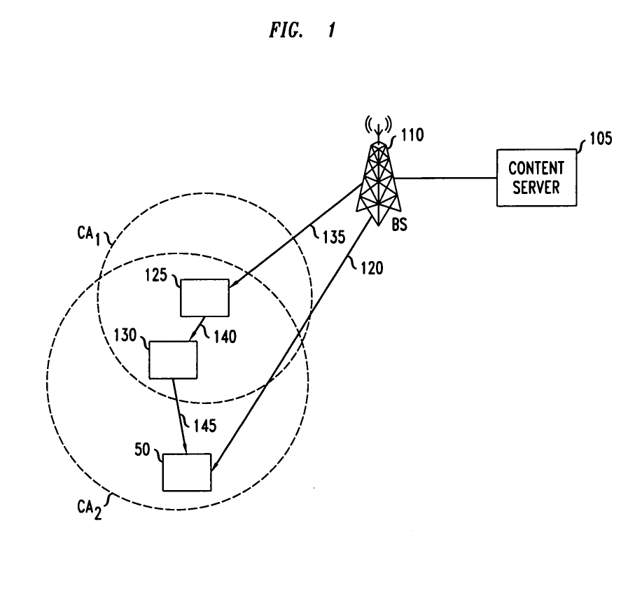

A Unified Cellular and Ad hoc Network (UCAN) may provide better cellular throughput to low data-rate users under poor channel conditions by forwarding data. FIG. 1 illustrates a conventional UCAN.

In the UCAN of FIG. 1, a network user 50 may request content. A content server 105, providing the requested content, may transmit the requested content to a base station 110. The base station 110 may send the requested packet to the network user 50 via a thin direct link 120 over a wireless interface such as 3G.

Alternatively, as shown, network users 125 and 130 have better reception than the network user 50. The network user 125 includes a radio coverage area CA₁. The network user 130, having a radio coverage area CA₂ including the location of the network user 50, is in the coverage area CA₁. The network user 50 is configured to setup a path via a Wi-Fi ad hoc mode. The path includes links 135, 140 and 145. Links 140 and 145 are communication links based on Wi-Fi ad hoc modes. Thus, the network user 125 forwards the requested content to the network user 130 over the Wi-Fi communications link 140. The network user 130 then forwards the content to the network user 50 over the Wi-Fi communications link 145.

However, the UCAN of FIG. 1 requires end-to-end connectivity for wireless multiple-hop communications. Moreover, the network user 50 requires an energy-hungry peer discovery procedure because network users in a UCAN periodically broadcast their identifications to discover other network users and/or hotspots. In other words, a Wi-Fi interface for a network user is always active.

Example embodiments are directed to methods of processing requests for content and methods of detecting user opportunities for the content. Example embodiments allow network operators to orchestrate short-range wireless interfaces in network users, such as Wi-Fi and Bluetooth, to enable “direct” device-to-device wireless data exchanges among users. Thus, coverage and capacity of sideloading may be improved because network users are used to exchange data among network users.

Data may be offloaded from network infrastructure by allowing a network user to act as a mobile Wi-Fi hotspot and providing content in the storage of the network user to another network user who requests and/or is interested in the data. The network operator may notify the network users in the network of availability of data spots (e.g., the providing network user). Since the network operator may notify the network users of the data spots, the network users in the network may reduce the amount of energy needed to scan for Wi-Fi hotspots since the network users do not need to keep a Wi-Fi interface active all of the time.

The inventors have recognized that load on a network is reduced by utilizing device-to-device connectivity (e.g., network users exchange content from their storage leveraging on-board short-range wireless interfaces). Network operators orchestrate device-to-device sideloading, by correlating network user locations and content demand/availability. The network operators may notify network users of available hotspots to reduce energy used for Wi-Fi hotspot scanning.

While Wi-Fi is used for describing a wireless interface for the transfer of data between network users or a network user and a hotspot, it should be understood that such transferring of data may occur using any protocol for transferring data between network users, with or without network facilitation, including Bluetooth, Wi-Fi, 802.11a/b/g/n, etc.

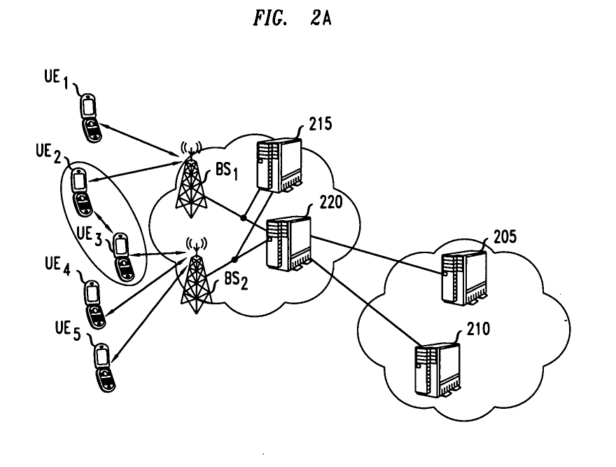

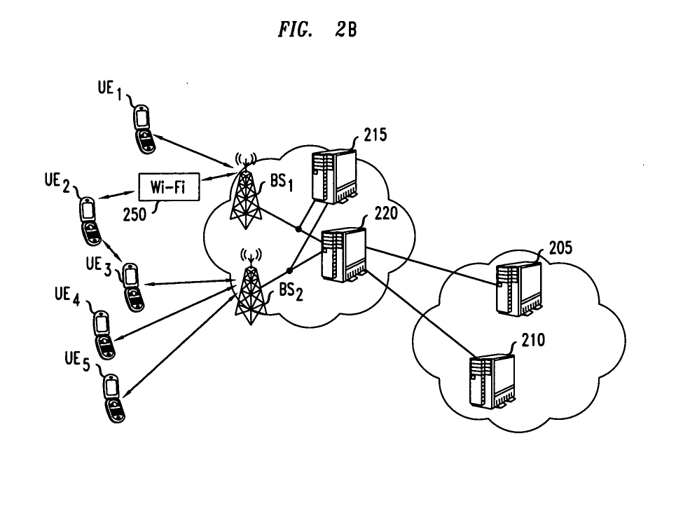

FIG. 2A illustrates a network architecture according to an example embodiment.

As shown in FIG. 2A, a network operator 200 provides a link between content providers 205 and 210 and network users UE₁-UE₅. While only five network users are illustrated, it should be understood that more or less than five network users may communicate with the network operator 200. Content may be vertically delivered to the network users UE₁-UE₅ through base stations BS₁ and BS₂. As shown, the network users UE₁ and UE₂ receive content vertically from the base station BS₁ and the network users UE₃-UE₅ receive content vertically from the base station BS₂. While the network operator 200 of FIG. 2A is shown as having two base stations BS₁ and BS₂, the network operator 200 may include additional base stations and/or elements which are not shown for the sake of clarity.

The network operator 200 includes a sideloading server 215 and a content providing server 220. The network operator 200 including the sideloading server 215 and content providing server 220 may be referred to as a network element. The sideloading server 215 is configured to track locations of the network users UE₁-UE₅ and monitor downloading patterns of the network users UE₁-UE₅. As will be described in more detail, the sideloading server 215 allows the network operator 200 to find potential peers in proximity to a network user that requests content and match the requesting network user with a peer for device-to-device sideloading.

For example, the network user UE₂ downloads a main page of the content provider 205 (e.g., www.youtube.com) and watches a video file posted therein. The sideloading server 215 stores information (user information) regarding at least the location of the network user UE₂ and indicating that the network user UE₂ downloaded the requested main page. As shown, the sideloading server 215 is in the vertical downloading path for the network users UE₁-UE₅. Thus, the user information may be determined based on known information that a network operator requires for downloading information. In other words, the network operator 200 may use a transparent proxy and/or packet inspection on a communication path between the network user UE₂ and the network operator 200 to acquire the user information. Alternatively, the network user UE₂ may report explicitly to the sideloading server 215 about available content in its cache.

The user information may be stored in a database of the sideloading server 215. The network operator 200 may access the user information in the database using a unique content identifier (e.g., Uniform Resource Locator (URL) or hashed URL) as a key to the network users having loaded the requested content.

At a later time, the network user UE₃ accesses the main page of the content provider 205 and requests to watch the same video file that the network user UE₂ watched. The network operator 200 may determine potential network users (potential peers) for sideloading based on the locations of the network users, data spots and downloading history of the network users, as stored in the sideloading server 215.

Since the sideloading server 215 monitors mobility, content downloading history and status of the network users UE₁-UE₅, the network operator 200 determines that the network user UE₂ is in the Wi-Fi radio range of the network user UE₃. The network operator 200 also determines that the network user UE₂ has stored the video the network user UE₃ requested based on the user information stored in the sideloading server. The network operator may use 250 m as Wi-Fi radio range.

If the network operator 200 determines that no network user is currently available for sideloading, the network operator 200 may deliver the requested content through the base station BS₂ (depending on channel conditions) or the network operator 200 may schedule a device-to-device transfer when the network user enters a data spot. Based on the data spot map received from the network operator 200, the network user UE₃ knows whether the network user UE₃ enters a data spot.

Whenever a network user enters a data spot, the network user may alert the network operator 200. Thus, the network operator 200 knows how many network users are in the data spot. Since the sideloading server 215 knows what content has been downloaded, the network operator 200 is configured to schedule device-to-device transfers to retrieve requested data from devices within the data spot. If the data spot includes a Wi-Fi hotspot, the network operator 200 may instruct the network user to connect to the Wi-Fi hotspot.

When the network operator 200 determines that the network user UE₂ is in the Wi-Fi radio range of the network user UE₃, the network operator 200 wakes up the network user UE₂ and enables Wi-Fi in an ad hoc mode. The network operator 200 may wake up the network user UE₂ by transmitting an enable signal to the network user UE₂. Herein, “wake up” refers to bringing a non-active interface into an active state. For example, waking up may include: (1) installing by the network operator 200 or the network user, a device driver dynamically for the network user, which activates Wi-Fi hardware, (2) setting the device driver to “Wi-Fi ad hoc” mode and (3) configuring the Wi-Fi device (channel, IP address, etc.) so that network users in “Wi-Fi ad hoc” mode can talk to each other. The enable signal indicates a request for activation of an interface (in this example, Wi-Fi). The enable signal may also indicate on what channel the Wi-Fi interface should be.

The Wi-Fi device may be deactivated by unloading the device driver.

Since the network operator 200 including the sideloading server 215 triggers the device-to-device sideloading, the security is improved over peer-to-peer networking because the network users do not need to broadcast information to unknown network users where no trust relationship exists. In example embodiments, the communicating network users have a trusting relationship with the network operator 200. Moreover, the network operator 200 may trigger interconnectivity between the network users while securing information between the network users communicating with each other.

Since the network operator 200 selects a target peer, the network operator 200 may generate a secrete key (e.g., a symmetric key) and transmit the key via a 3G channel to both the network user requesting content and the potential peer. The network user requesting content and the potential peer may then setup a secure channel using Wi-Fi ad hoc mode and the secrete key. The key that is transmitted via the 3G channel may include information indicating a Service Set Identifier (SSID) and channel number. Using the same SSID and channel number identified in the key, the network user requesting content and potential peer may setup a communications channel.

Depending on a network user's preferences and/or an agreement with the network operator 200, the network user may or may not be notified when the network user receives an enable signal.

When the network user UE₃ receives information from the network operator 200 indicating a target peer, the network user UE₃ may activate its Wi-Fi interface, if the Wi-Fi interface is not already activated. If the network user UE₃ is not in a data spot, the network user UE₃ may reactivate its Wi-Fi interface when the network user UE₃ enters a data spot.

If the network user UE₂ enables its Wi-Fi interface, the network user UE₃ sends a message including a request to receive the requested video. The request message may include the key (described above) transmitted by the network operator 200 to both the network user UE₃ (the requesting network user) and the network user UE₂ (the potential peer). The network user UE₂ receives the request message and directly transmits the video to the network user UE₃ via Wi-Fi ad hoc communications. For example, the network user UE₂ transmits the video to the network user UE₃ if a key in the request message matches the key received by the network user UE₂.

FIG. 2B illustrates a method of extending the coverage of existing Wi-Fi hotspots. FIG. 2B is substantially similar to FIG. 2A. Thus, for the sake of brevity and clarity, only differences between FIG. 2B and FIG. 2A will be discussed.

As shown, the network user UE₂ communicates with a Wi-Fi hotspot 250. In FIG. 2B, the network user UE₃ is not within the coverage range of the Wi-Fi hotspot 250. Based on the user information in the sideloading server 215, the network operator 200 knows that the network user UE₃ is within the radio range of the network user UE₂. The network operator 200 may initiate a data transfer from the Wi-Fi hotspot 250 to the network user UE₃ via the network user UE₂, thereby extending Wi-Fi coverage.

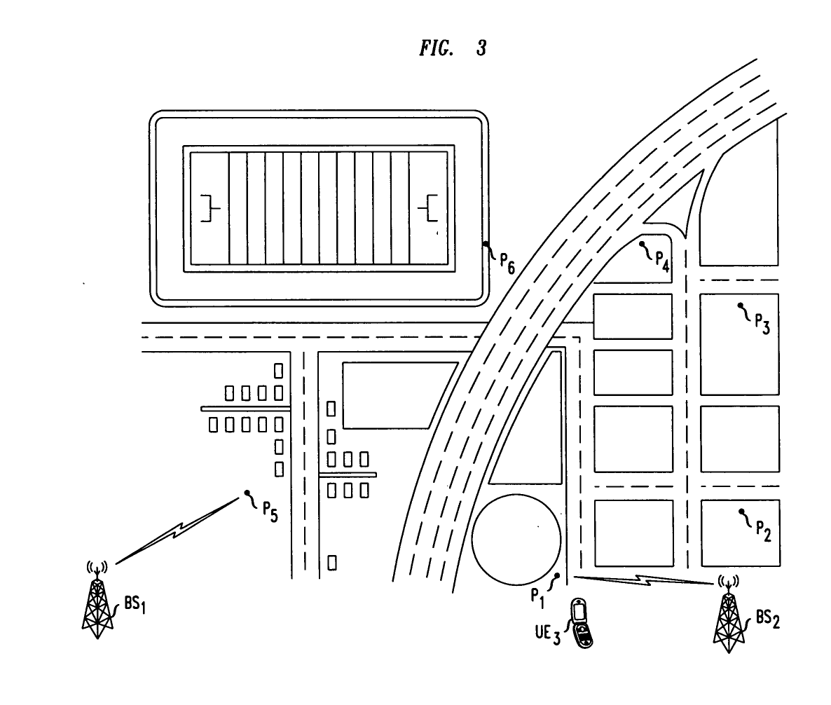

FIG. 3 illustrates an overview of the data spot map determined by the sideloading server 215. As mentioned above, the sideloading server 215 monitors the locations of network users (e.g., UE₁-UE₅). More specifically, the sideloading server 215 samples locations of the network users and builds a data spot map which is transmitted to the network users. The sideloading server 215 may sample the location of the network users by any known method such as GPS or accelerometer measurements. For example, the sideloading server 215 may receive measurements from a network user periodically or after the network user has moved a determined distance. In order to save battery life of the network users, the network users may at times use accelerometer measurements instead of GPS. The network users may also us “inertial navigation” techniques to locate their respective locations (using an accelerometer and a compass), as described in Towards Mobile Phone Localization without War-Driving, Choudary et al. (http://people.ee.duke.edu/˜romit/courses/s10/material/compacc.ppt), the entire contents of which are hereby incorporated by reference.

During peak hours, network users may be instructed to report their locations to the network operator 200 periodically (e.g., every three minutes) to conserve network resources.

In at least one example, the sideloading server 215 initially receives GPS locations from the network user. When the network user moves, accelerometer readings and compass readings are used to measure the change of distance and direction. The sideloading server 215 randomly samples location information (e.g., GPS and/or accelerometer readings and compass readings) from network users and estimates locations/radii of the data spots. For example, the sideloading server may determine a data spot exists in a location if the density of network users is over a threshold.

The localization of the network users may be done locally (at the base station level), and the sideloading server 215 may sample the network users' locations at a very low rate to build a data spot, so privacy is preserved during the sampling phase.

The sideloading server 215 may also use historical data to better estimate the data spots. For example, the sideloading server 215 may predict that a bus stop or train station will be populated during commuting hours and less populated during the weekend. Periodically, the sideloading server 215 transmits the data spot map to the network users.

When a network user enters a data spot, the current position of the network user within the data spot is entered in the sideloading server 215. The network operator 200 examines the requested content and, based on the user information of the network users in the data spot, determines whether there is another network user in the data spot that has the requested content. If another network user within the data spot has the requested content, the network operator 200 instructs the requesting network user to retrieve the content via Wi-Fi (or another protocol such as Bluetooth), as described with reference to FIG. 2A.

In FIG. 3, the network user UE₃ is illustrated as an example. The network user UE₃ is at a location P₁ within a generally populated area, such as a city, suburb, town, etc. The network user UE₃ may be associated with base station BS₂ and may be provided content, such as voice, text, email, html, streaming video, internet radio, SMS data, etc., over network-controlled spectrum available between the base station BS₂ and the network user UE₃. That is, when the network user UE₃ requests certain content, such as placing a call, for example, that content maybe delivered vertically from the centralized network, such as through a centralized home agent, to the network user UE₃ through a wireless/cellular connection between the network user UE₃ and the base station BS₂. Of course, the network may also deliver the requested content through data spots P₂-P₆ which may be transmission resources, such as a satellite, Wi-Fi access node/hotspot, or land line connection, for example.

Requested content may be unavailable directly, at the time requested and/or thereafter, from the base station BS₂ because of a lack of network transmission resources. For example, the base station BS₂ may reach a data throughput limit, exhaust its available spectrum, suffer a power outage, or otherwise lack transmission resources to readily provide all or some requested content to the network user UE₃ associated with only the base station BS₂. Similarly, the network may be overburdened at higher network levels or lose access to content, such as the Internet, at the higher network level, and the requested content may not be vertically delivered to the base station UE₃. This may result in the above-discussed problem where the network user UE₃ receives requested content slowly, in an unusable or delayed fashion, or not at all.

Within the area shown in FIG. 3, several other data spots may have greater transmission resources may provide the requested content to the network user UE₃. For example, data spots P₂ and P₃ may offer free public Wi-Fi or other Internet services available to the network user UE₃ in the form of publicly-accessible wireless hotspots or other access nodes because the data spots P₂ and P₃ are within buildings. Or, for example, a heavily-trafficked road, such as a highway or interstate may carry motor traffic, some of which may include users capable of sideloading requested content to the network user UE₃, so as to form a data spot along the road within transmitting distance of one of the Wi-Fi hotspots P₂ and P₃. Or, for example, the base station BS₁ serving the data spot P₅ having available transmission resources may provide the desired content to the network user UE₃. With reference to FIG. 2A, a coverage area the data spot P₅ may include the location of the network user UE₃ and thus, a network user in the data spot P₅, such as the network user UE₂, may transmit data to the network user UE₃. Or, for example, a crowded stadium may be filled with other network users capable of sideloading requested content to the network user UE₃ and form the data spot P₆.

Although the network user UE₃ cannot receive requested content, such as high-bandwidth streaming videos, for example, in a timely or complete fashion at P₁ because of a lack of network transmission resources at P₁ where access to only the base station BS₂ is possible, several other data spots P₂₋₆ accessible to the network user UE₃ may have transmission resources to provide the requested content. Examples of such transmission resources in FIG. 3 may include a network resource like the base station BS₁, a publicly- or privately-operated accessible Internet hotspot, an orbiting satellite, and/or an ad hoc hotspot where sideloading the requested content is possible, in any combination.

Specific geographic positions, such as data spots P₂₋₆ described in the example of FIG. 3, have communicative access to sufficient transmission resource(s) for access/consumption of the requested content. As such, data spots do not include positions such as P₁, where any portion of requested content is not readily available to network user UE₃, because of a lack of transmission resources to provide the content, even though some other or partial network coverage or services may be available at the position.

Using the data spots, the network operator 200 may also transmit information regarding highly available data to network users within a data spot. The highly available data is based on the type of data and the number of network users that have downloaded the type of data. The network user may then activate its Wi-Fi interface if the mobile device network device desires any of the highly available data. The network operator 200 may also inform the network users of popular files for the data spot.

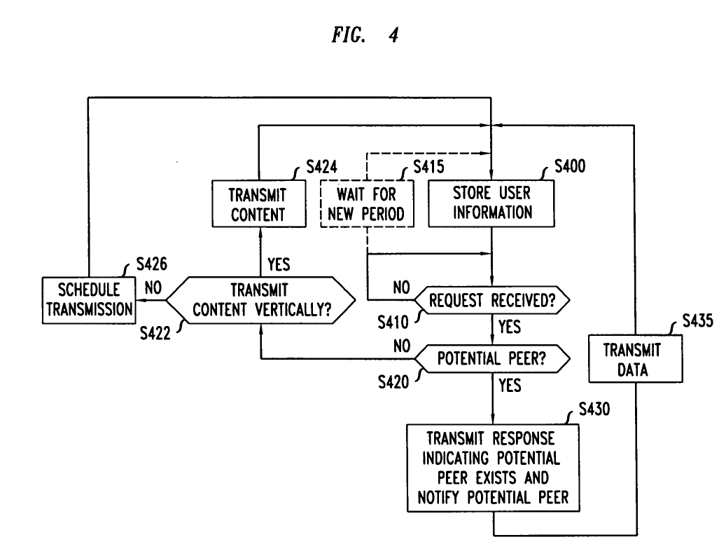

FIG. 4 illustrates a method of processing a request for content. It should be understood that the method shown in FIG. 4 may be performed by the network operator 200 and, therefore, the discussion of FIGS. 2A and 3 supplement the discussion of FIG. 4.

At S400, the network operator and, more specifically, a sideloading server (e.g., the sideloading server 215) store user information for each network user. The user information may include the location of the network user and received content information such as information regarding downloaded content. The location of each network user may be updated periodically and when a network user enters a new data spot.

At S410, the network operator determines whether a request for content is received from a network user. If the network operator receives a request, the network operator determines whether a potential peer from the plurality of network users exists within a radio range of the network user and has the requested content, at S420. For example, with reference to FIG. 2A, the network operator 200 determines that the network user UE₂ is in the Wi-Fi radio range of the network user UE₃ and the network user UE₂ has stored the video the network user UE₃ requested.

Processing a request and collection of user information may be independent procedures. While the collection of user information may be periodic and triggered by a download event, the network operator responds to a request for content with minimal or no wait period. Therefore, if no request is received at S410, the network monitor continues to monitor whether a request has been received. As stated above, the network operator stores user information periodically. Thus, when a request is not received, the network operator waits for a new period at S415 and then updates and stores user information at S400 in addition to determining whether a request is received.

If a potential peer exists, the network operator sends a response to the network user indicating that a potential peer exists, at S430. If multiple potential peers exist, the network user may choose at least one of the potential peers and notify the network operator. If the network user chooses two potential peers, the requested content is downloaded through two potential peers in parallel. At S430, the network operator also may transmit an enable signal to wake up the potential peer and enable a Wi-Fi interface of the potential peer in an ad hoc mode. As provided above, the enable signal indicates a request for activation of an interface (in this example, Wi-Fi). The enable signal may also indicate on what channel the Wi-Fi interface should be.

At S435, the network operator transmits data to the network user. If the network user establishes a connection with the potential peer(s), then the network user downloads the requested content from the potential peer(s) over Wi-Fi or from both the potential peer(s) over Wi-Fi and the network operator over 3G (e.g., using HTTP byte-range primitives).

The network user may retrieve different segments of the requested content from different sources. For example, the network user may send complementary requests to different data sources. The network operator applies several policies that are executed by the network user. The policies may include: (1) always load a first plurality of bytes over 3G to avoid start up latencies, (2) if several potential peers are available, choose only one (e.g., randomly) and (3) load remaining content from the potential peer only. By using HTTP byte-range primitives, the data sources do not need to segment the requested content a priori. The subset of data to be transferred may be signaled implicitly in the request message.

If the network user does not establish a connection with the potential peer, the network user attempts to download the requested content from the network operator and returns to S400.

To allow for secure communications between the network user requesting content and the potential peer, the network operator may transmit a key to both the network user requesting content and the potential peer.

Based on the communications between the network user and the potential peer, the network operator updates the user information at S400.

If the sideloading server determines that no potential peer exists, the network decides whether to transmit the requested content vertically to the network user based on channel conditions such as available bandwidth at S422. At S424, the network operator decides to transmit the content vertically to the network user based on the channel conditions. For example, if the network user has poor 3G speed when the channel is bad (e.g., behind a building) or the cell is overloaded, the network operator will not transmit the content to the network user. However, when the channel conditions improve, the network operator may transmit the content to the network user. The sideloading server then stores user information regarding the downloaded content and locations of the network users at S400.

If the network operator does not transmit the content to the network user at S422, the network operator may schedule the content transmission at S426. The content transmission may be scheduled for when the network user enters a data spot with a potential peer or when the network operator may transmit the requested content directly.

The sideloading server then stores user information at S400 including the scheduled transmission and location of the network user.

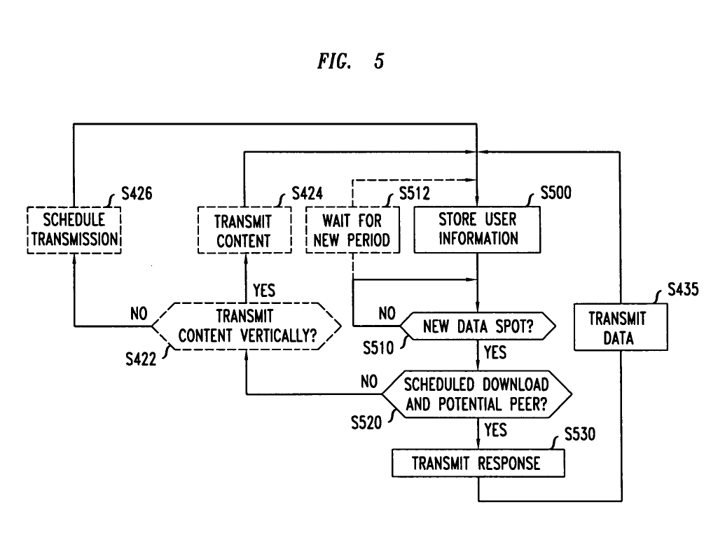

FIG. 5 illustrates a method of initiating an interconnection between a network user and a potential peer. It should be understood that the method shown in FIG. 5 may be performed by the network operator 200 and, therefore, the discussion of FIGS. 2A and 3 supplement the discussion of FIG. 5.

At S500, the sideloading server stores user information. S500 is the same as S400 and, therefore, will be not be described in greater detail.

Based on the user information, the sideloading server determines whether the network user is entering a new data spot at S510. Similar to FIG. 4, while the collection of user information may be periodic and triggered by a download event, a network user informs the network operator when the network user enters a new data spot. Consequently, the network operator immediately knows when a network user enters a new data spot. Therefore, if the network user does not enter a new data spot at S510, the network monitor continues to monitor whether the network user enters a new data spot. As stated above, the network operator stores user information periodically. Thus, when the network user does not enter a new data spot, the network operator waits for a new period at S512 and then updates and stores user information at S500, in addition to determining whether the network user enters a new data spot.

If the network user is not entering a new data spot, the method returns to S500, where user information is stored at a next period. Using a data spot map, the network user may notify the network operator when the network user enters a data spot.

If the network user is entering a new data spot, the sideloading server determines whether a download is scheduled for the network user and, if so, whether any potential peers are in the new data spot that have the requested content at S520. At S520, the sideloading server may also determine whether any potential peers exist that have content the network user may want based on the network user's downloading history.

If no potential peer exists in the new data spot, the method returns to S500, where user information is stored including the location of the network user. Here, it should be understood that the method of FIG. 4 may be used in conjunction with the method of FIG. 5. More specifically, prior to returning to S500, the network operator may determine whether to transmit the content directly or schedule transmission of requested content, if the network operator received a request. Therefore, S422, S424 and S426 are illustrated for when the network operator receives a request for content.

If a potential peer does exist, the sideloading server, transmits a response (or a signal indicating content based on downloading history is available) to the network user and an enable signal to the potential peer at S530. As stated above, the enable signal requests activation of an interface such as a Wi-Fi interface, to initiate “direct” interconnection between the network user and the potential peer. At S435, the network operator transmits data to the network user. S435, shown in FIG. 5, is the same as S435 as shown in FIG. 4. Therefore, for the sake of brevity and clarity, a further description will not be provided.

The sideloading server then updates and stores user information at S500.

Since the network users transmit their locations, respectively, to the sideloading server when the network users enter a data spot, the sideloading server may detect that a potential peer has entered the data spot of the requester. The sideloading server may then initiate an interconnection between the requester and the potential peer, as described in FIGS. 4 and 5.

As described above, example embodiments allow a network operator to trigger a sideloading process, thereby reducing energy used for peer discovery, improved security for device-to-device communications and providing novel content delivery services.

Example embodiments being thus described, it will be obvious that the same may be varied in many ways. Such variations are not to be regarded as a departure from the spirit and scope of example embodiments, and all such modifications as would be obvious to one skilled in the art are intended to be included within the scope of the claims.

For example, example embodiments may use collaboration between network operators and content providers. Since network operators monitor mobility and content downloading, the network operators may provide mobility information to the content providers. Using the mobility information, the content providers may transmit a similar set of content files to network users so that the content providers can minimize their downstream bandwidth usage. For the network operators, geographic locality of data exchanges is increased.

What is claimed is:

1. A method of processing a request for content comprising:
storing, at a network element, user information for a plurality of users, the user information including locations of the plurality of users and received content information;
receiving a request for content from a requester of the plurality of users;
determining a potential peer from the plurality of users based on the request for content and the user information; and
sending a response to the requester based on the determining.

2. The method of claim 1, wherein as part of the response, the network element identifies the user information to the requester.

3. The method of claim 1, further comprising:
sending an enable signal to the potential peer.

4. The method of claim 3, wherein as part of the enable signal, the network element requests activation of an interface.

5. The method of claim 4, wherein the interface is Bluetooth or Wi-Fi.

6. The method of claim 3, wherein the sending the enable signal sends a key to the potential peer.

7. The method of claim 6, wherein the sending the response sends the key to the requester.

8. The method of claim 1, wherein the received content information identifies content downloaded for each user.

9. The method of claim 8, wherein the determining determines whether the requested content matches the received content information from one of the plurality of users.

10. The method of claim 8, wherein the determining determines the potential peer as the user having the requested content.

11. The method of claim 1, further comprising:
periodically receiving location information from the plurality of users.

12. The method of claim 1, further comprising:
transmitting the requested content to the potential peer.

13. A method of initiating an interconnection between a requester of a plurality of users and a potential peer of the plurality of users:
storing, at a network element, user information for the plurality of users, the user information including a location of the user and received content information;
receiving a request for content from the requester;
first determining a data spot of the requester, the data spot being an area where the requester has communicative access to transmission resource(s) for access and consumption of the requested content;
second determining the potential peer in the data spot based on the first determining; and
transmitting a response to the requester and an enable signal to the potential peer if the requester is located in the data spot.

14. The method of claim 13, wherein as part of the enable signal, the network element requests activation of an interface.

15. The method of claim 14, wherein the interface is Bluetooth or Wi-Fi.

16. The method of claim 13, further comprising:
transmitting map information to the requester, the map information indicating data spots.

17. The method of claim 16, wherein the transmitting map information transmits map information based on the user information.

18. The method of claim 13, further comprising:
receiving location information from the requester, the location information indicating that the requester is in the data spot.

19. The method of claim 13, wherein the transmitting transmits a key to the potential peer.

20. The method of claim 19, wherein the transmitting transmits the key to the requester.
